(19) United States
(12) Patent Application Publication
(10) Pub. No.: US 2005/0122465 A1
(43) Pub. Date: Jun. 9, 2005

(54) Method for manufacturing an apparatus using electro-optical modulating material

(75) Inventor: Seigo Togashi, Sakade-shi (JP)

Correspondence Address: Finnegan, Henderson, Farabow,;Garrett & Dunner, L.L.P., 1300 I Street, N.W., Washington, DC, 20005-3315, US

(73) Assignee: CITIZEN WATCH CO., LTD.

(21) Appl. No.: 10/952,181

(22) Filed: Sep. 29, 2004

(30) Foreign Application Priority Data
Sep. 30, 2003 (JP) 2003-339618

(51) Int. Cl. G02F 1/1339

(52) U.S. Cl. 349/190

(57) ABSTRACT

A method for manufacturing an apparatus using an electro-optical modulating material such as a liquid crystal, comprising the steps of: (a) forming a cell by bonding together a first substrate (10) and a second substrate (20) by a sealing member (17) with a gap (15) yet to be filled with the electro-optical modulating material provided between the first and the second substrate, wherein the first substrate (10) includes at least a first electrode (11) and the second substrate (20) includes at least a second electrode (24) and an optically reflective member (21) having a light-transmitting portion (22); (b) forming a photocuring resin layer (30a) on a surface of the second substrate (20) of the cell opposite from the gap (15); and (c) irradiating the photocuring resin layer (30a) with light projected from below the first substrate (10) and passed through the gap (15), the light-transmitting portion (22), and the second substrate (20), and thereby forming a microlens for converging light, directed into the second substrate (20) toward the gap (15), onto the light-transmitting portion.

### CROSS REFERENCE TO RELATED APPLICATION

This application claims priority of Japanese Patent Application Number 2003-339618, filed on Sep. 30, 2003.

### BACKGROUND OF THE INVENTION

1. Field of the Invention

The present invention relates to a method for manufacturing an apparatus using an electro-optical modulating material, for example, a liquid crystal material, between two substrates. More particularly, the invention relates to a method for forming microlenses in such an apparatus.

2. Description of the Related Art

Liquid crystal displays are widely used as display devices for electronic apparatuses such as touch panels and portable telephones. For such liquid crystal displays, there has been a need to improve the display brightness.

A reflective mode liquid crystal display apparatus, which uses a reflective film or reflective plate, does not require the provision of backlighting, as it displays images by using external ambient light. In the reflective mode liquid crystal display apparatus, however, as the display is illuminated by using only the ambient light available from the outside environment or indoor lighting, the display becomes dark if the amount of ambient light is not sufficient.

On the other hand, a transmissive mode liquid crystal apparatus, which uses light from a backlight mounted underneath the liquid crystal device, consumes much power and is therefore not suitable for portable electronic apparatuses.

In view of this, a transflective mode liquid crystal apparatus has been developed that has the characteristics of both the reflective mode and transmissive mode liquid crystal apparatuses.

The transflective mode liquid crystal apparatus includes a backlight mounted behind the liquid crystal panel forming part of the liquid crystal display apparatus, and displays images in a bright light environment by using only external ambient light as in the reflective mode liquid crystal apparatus, while in a low light environment, it display images by using illumination from the backlight. By switching between the external light and the illumination from the backlight depending on the brightness of the environment, the transflective mode liquid crystal apparatus not only can achieve a reduction in power consumption, but can display crisp images even in a low light environment.

In a liquid crystal apparatus equipped with a backlight, it is practiced to form microlenses in order to further increase the display brightness.

In JP-H9-166701A (FIG. 1), there is disclosed a method that forms a microlens array on a flat transparent substrate by using a resin composition that cures with irradiation with curing energy.

In JP-2003-84276A (FIGS. 1 and 6, and paragraphs 0023 to 0027 and 0045 to 0048), there is disclosed a method that forms a reflective film on a transparent substrate, followed by the formation of a plurality of microscopic holes through the reflective film to expose the underlying transparent substrate, and then forms a microlens array by diffusing a material having a different refractive index than that of the transparent substrate, into the transparent substrate through the plurality of microscopic holes by using the reflective film as a mask.

In JP-2004-18106A (FIGS. 1 and 3, and paragraphs 0049 to 0057), there is disclosed a method that forms on one surface of a glass substrate an optically reflective film provided with a light-transmitting portion for each pixel, applies a photosensitive resist material on the opposite surface of the glass substrate, exposes the photosensitive resist material to light by using the optically reflective film as a photomask, and develops the resist to remove the unexposed portions thereof, thereby forming microlenses in positions corresponding to the respective light-transmitting portions.

In JP-2001-133762A (FIG. 1), there is disclosed a method for manufacturing a liquid crystal apparatus, in which two mother substrates are bonded together by a sealing member with a gap provided between the substrates, thus constructing the pair of mother substrates with a plurality of empty cells formed therebetween, then the mother substrates are ground to reduce the thickness, and a liquid crystal is injected into the gap between the mother substrates.

As disclosed in Patent Documents 1 to 3, according to the prior art methods for forming microlenses in an apparatus that uses an electro-optical modulating material such as a liquid crystal material, the microlenses are formed on one substrate, and thereafter the cells are formed by bonding the one substrate to the other substrate with a sealing material.

However, in the prior art methods, as the step of bonding the substrates together by a sealing material is performed after forming the microlenses on one substrate, the number of process steps performed after the formation of the microlenses increases, increasing the risk of scratching the microlenses. There is also the possibility that, during the fabrication process of the microlenses, dust and other foreign particles may adhere to the substrate, resulting in a degradation of image quality.

It is accordingly an object of the present invention to provide a method for manufacturing an apparatus that uses an electro-optical modulating material such as a liquid crystal, while solving the problems associated with the prior art.

### SUMMARY OF THE INVENTION

According to the present invention, there is provided a method for manufacturing an apparatus using an electro-optical modulating material, comprising the steps of:
(a) forming a cell by bonding together a first substrate and a second substrate by a sealing member with a gap yet to be filled with the electro-optical modulating material provided between the first and the second substrate, wherein the first substrate includes at least a first electrode and the second substrate includes at least a second electrode and an optically reflective member having a light-transmitting portion;
(b) forming a photocuring resin layer on a surface of the second substrate of the cell opposite from the gap; and
(c) irradiating the photocuring resin layer with light projected from the first substrate and passed through the gap, the light-transmitting portion, and the second substrate, and thereby forming a microlens for converging light, which is directed into the gap passing through the second substrate, onto the light-transmitting portion.

According to the present invention, there is also provided a method for manufacturing an apparatus using an electro-optical modulating material, comprising the steps of:
(a) forming a cell by bonding together a first substrate and a second substrate by a sealing member with a gap yet to be filled with the electro-optical modulating material provided between the first and the second substrate, wherein the first substrate includes at least a first electrode and the second substrate includes at least a second electrode and an optically reflective member having a light-transmitting portion;
(b) forming a photocuring resin layer on a surface of the second substrate of the cell opposite from the gap;
(c) filling the electro-optical modulating material into the gap and sealing the gap; and
(d) irradiating the photocuring resin layer with light projected from below the first substrate and passed through the gap filled with the electro-optical modulating material, the light-transmitting portion, and the second substrate, and thereby forming a microlens for converging light, which is directed into the gap filled with the electro-optical modulating material passing through the second substrate, onto the light-transmitting portion.

According to the present invention, color filters may be provided between the first substrate and the second substrate.

Further, the center of a pixel defined by the first electrode on the first substrate and the second electrode on the second substrate is substantially coincident with the center of the light-transmitting portion when viewed in a direction normal to the first substrate.

According to the present invention, a plurality of light-transmitting portions are provided for each pixel defined by the first electrode on the first substrate and the second electrode on the second substrate, and a plurality of microlenses are formed for each pixel.

According to the present invention, the microlens forming step is followed by the steps of:
(e) providing a first polarizer on a side of the first substrate opposite from the gap; and
(f) providing a second polarizer and a backlight on the same side as the microlens.

According to the present invention, the electro-optical modulating material to be filled into the gap may be a liquid crystal material. In this case, in the step (d) of forming the microlens by irradiating the photocuring resin layer with light, the amount of the light transmitted for irradiation can be controlled by driving the thus filled liquid crystal by applying a voltage between the first electrode and the second electrode.

A method according to the present invention comprises the steps of:
(a) forming a plurality of cells by bonding together a first mother substrate and a second mother substrate by a sealing member with a gap yet to be filled with an electro-optical modulating material provided between the first and the second mother substrates, the sealing member comprising a first sealing member provided along edges of the first and second mother substrates and a second sealing member provided so as to enclose each of the cells, wherein the first mother substrate includes a plurality of cell forming portions, each of which includes at least a first electrode, and the second mother substrate includes a plurality of cell forming portions, each of which includes at least a second electrode and an optically reflective member having a light-transmitting portion;
(b) forming a photocuring resin layer on a surface of the second mother substrate opposite from the gap; and
(c) irradiating the photocuring resin layer with light projected from the first mother substrate and passed through the gap, the light-transmitting portion, and the second mother substrate, and thereby forming a microlens for converging light, which is directed into the gap passing through the second mother substrate, onto the light-transmitting portion.

In the above case, a light-blocking member may be provided in any portion of the first and second mother substrates, other than the cell forming portions, so that the microlens will not be formed on that portion.

Further, the center of a pixel defined by the first electrode on the first mother substrate and the second electrode on the second mother substrate is substantially coincident with the center of the light-transmitting portion when viewed in a direction normal to the first mother substrate.

Furthermore, the first sealing member forms a double seal along a portion of the edges of the mother substrates, and the double seal forms a passage communicating between an outside environment and the gap formed between the first and second mother substrates.

According to the present invention, the microlens forming step is followed by the step of:
(d) cutting the first and second mother substrates, which contain the plurality of cells with the microlens formed thereon, into rectangular pieces, and injecting the electro-optical modulating material through an injection port formed in the second sealing member and thereafter sealing each of the cells.

This step is further followed by the step of:
(e) cutting the plurality of cells, each filled with the electro-optical modulating material and sealed, into separate individual cells.

### BRIEF DESCRIPTION OF THE DRAWINGS

The above object and features of the present invention will be more apparent from the following description of the preferred embodiments with reference to the accompanying drawings, wherein:

FIG. 1 is a diagram showing one example of the structure of a transflective mode liquid crystal apparatus;

FIG. 2 is a cross-sectional view taken along line A-A in FIG. 1;

FIG. 3 is a diagram showing one example of the structure of the transflective mode liquid crystal apparatus;

FIG. 4 is a process diagram showing essential portions for explaining a method for manufacturing a liquid crystal apparatus equipped with microlenses according to a first embodiment of the present invention;

FIG. 5 is a process diagram showing essential portions for explaining the method for manufacturing the liquid crystal apparatus equipped with microlenses according to the first embodiment of the present invention;

FIG. 6 is a process diagram showing essential portions for explaining a method for manufacturing a liquid crystal apparatus equipped with microlenses according to a second embodiment of the present invention;

FIG. 7 is a process diagram showing essential portions for explaining the method for manufacturing the liquid crystal apparatus equipped with microlenses according to the second embodiment of the present invention;

FIG. 8 is a diagram showing one example of a cross section of a color liquid crystal apparatus equipped with microlenses;

FIG. 9 is a process diagram showing essential portions for explaining a method for manufacturing a liquid crystal apparatus equipped with microlenses according to a third embodiment of the present invention;

FIG. 10 is a process diagram showing essential portions for explaining the method for manufacturing the liquid crystal apparatus equipped with microlenses according to the third embodiment of the present invention;

FIG. 11 is a process diagram showing essential portions for explaining a method for manufacturing a liquid crystal apparatus equipped with microlenses according to a fourth embodiment of the present invention;

FIG. 12 is a process diagram showing essential portions for explaining the method for manufacturing the liquid crystal apparatus equipped with microlenses according to the fourth embodiment of the present invention;

FIG. 13 is a process diagram showing essential portions for explaining a method for manufacturing a liquid crystal apparatus equipped with microlenses according to a fifth embodiment of the present invention;

FIG. 14 is a process diagram showing essential portions for explaining the method for manufacturing the liquid crystal apparatus equipped with microlenses according to the fifth embodiment of the present invention;

FIG. 15 is a process diagram showing essential portions for explaining the method for manufacturing the liquid crystal apparatus equipped with microlenses according to the fifth embodiment of the present invention;

FIG. 16 is a diagram showing the step of forming microlenses on a mother substrate having a plurality of empty cells formed thereon;

FIG. 17 is a diagram showing the step of forming microlenses on a mother substrate having a plurality of empty cells formed thereon;

FIG. 18 is an enlarged plan view in perspective showing the portion indicated by Z in FIG. 13 after the microlenses have been formed;

FIG. 19 is a process diagram showing essential portions for explaining a method for manufacturing a liquid crystal apparatus equipped with microlenses according to a sixth embodiment of the present invention; and

FIG. 20 is a process diagram showing essential portions for explaining a method for manufacturing a liquid crystal apparatus equipped with microlenses according to a seventh embodiment of the present invention.

### DESCRIPTION OF THE PREFERRED EMBODIMENTS

The present invention will be described by taking a transflective mode liquid crystal apparatus as an example of the apparatus that uses an electro-optical modulating material.

In FIG. 1, reference numeral 11 indicates a first electrode, and 24 a second electrodes, and a liquid crystal layer is sandwiched between the first and second electrodes, forming a pixel 28 where the first and second electrodes 11 and 24 overlap. In FIG. 1, a reflective film 21 as an optically reflective member is formed over the entire surface underneath the array of second electrodes 24, and openings 22 as light-transmitting portions are formed in the reflective film 21, one each in a position corresponding to each pixel 28. The openings 22 shown here are rectangular in shape, but may be formed in any other suitable shape, such as a stripe shape, a polygonal shape, or a circular shape.

Reference numeral 30 indicates an array of microlenses formed below the reflective film 21 at positions opposite the respective openings 22.

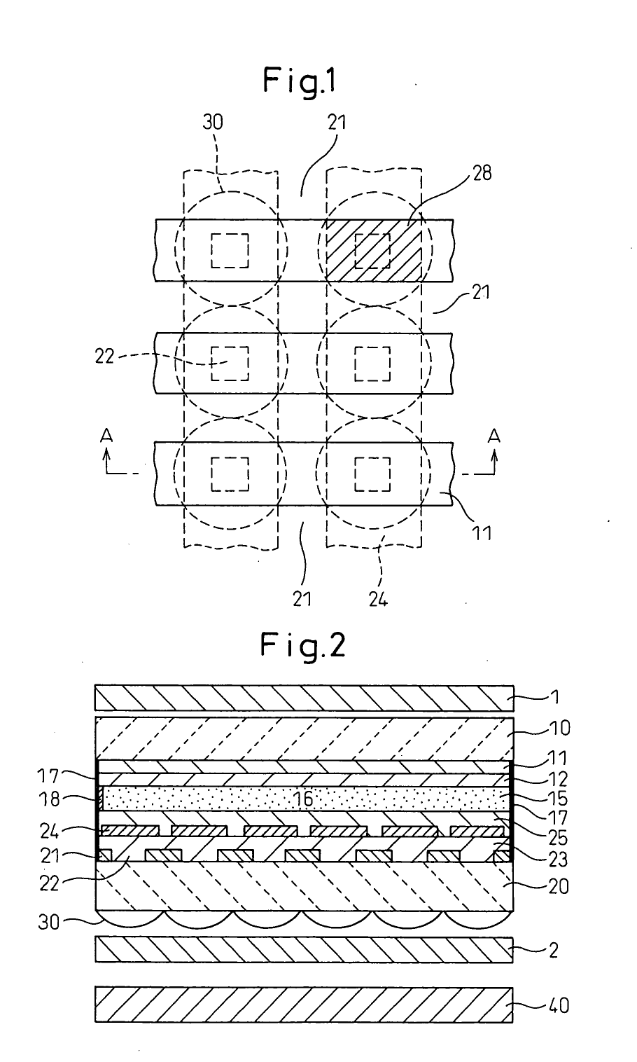

FIG. 2 is a cross-sectional view taken along line A-A in FIG. 1. In FIG. 2, reference numeral 10 is a first transparent substrate with the first electrodes 11 and a first alignment film 12 formed thereon. Reference numeral 20 is a second transparent substrate on one surface of which the microlenses 30 are formed, and on the other surface of which the reflective film 21 with the openings 22 formed therein, an insulating film 23, the second electrodes 24, and a second alignment film 25 are formed one on top of another. The first and second substrates 10 and 20 are arranged opposite each other with a gap 15 provided therebetween, and are bonded together by a sealing member 17. A liquid crystal 16 is injected into the gap 15 through an injection port formed in the sealing member 17, and the injection port is sealed with a sealant 18.

An image is formed by driving the liquid crystal 16 by applying a voltage between the first and second electrodes 11 and 24.

In FIG. 2, a first polarizer 1 is attached to the viewer side of the first substrate 10. The plurality of first stripe electrodes 11 made, for example, of indium tin oxide are formed parallel to each other on the same side of the first substrate 10 as the liquid crystal layer 16, and the first alignment film 12 is formed over the first electrodes 11.

On the other hand, the conductive reflective layer or reflective film 21 with the plurality of openings 22 formed therein is formed on the same side of the second transparent substrate 20 as the liquid crystal layer 16. The area of each opening 22 is 25% to 60% of each pixel 28, and preferably 40% to 50%. This percentage can be changed according to the preference of the customer who uses the product.

A second polarizer 2 and a backlight 40 are mounted on the same side of the second substrate 20 as the microlenses 30.

As the transflective mode liquid crystal apparatus shown in FIG. 2 has optically reflective portions (reflective film 21) and optically transmissive portions (openings 22), if the area of the openings is large, the amount of transmitted light increases, increasing the amount of backlighting that can be used. Conversely, if the area of the openings is small, the amount of reflected light increases, increasing the amount of reflected light that can be used.

In the transflective mode liquid crystal apparatus shown in FIG. 2, the microlenses 30 are provided to enhance the capability for gathering the light from the backlight 40. Accordingly, the area of the openings 22 can be made smaller than would be the case if the microlenses were not provided, and as a result, the percentage of the reflective area can be made larger than the earlier stated percentage to increase the amount of reflected light that can be used.

The reflective film 21 is formed, for example, from aluminum (Al) or an aluminum alloy such as an aluminum-neodymium alloy. The second electrodes 24 made, for example, of indium tin oxide (hereinafter abbreviated ITO) are formed on the reflective film 21 with the insulating film 23 interposed therebetween. The insulating film 23 is provided to prevent short-circuiting between the conductive reflective film 21 and the second electrodes 24. The second alignment film 25 is formed over the second electrodes 24.

FIG. 2 has shown the case where the reflective film 21 is formed over the entire surface of the second substrate 20, but the reflective film may be formed in the shape of stripes extending along the respective second electrodes 24, each stripe having substantially the same width as that of each second electrode 24.

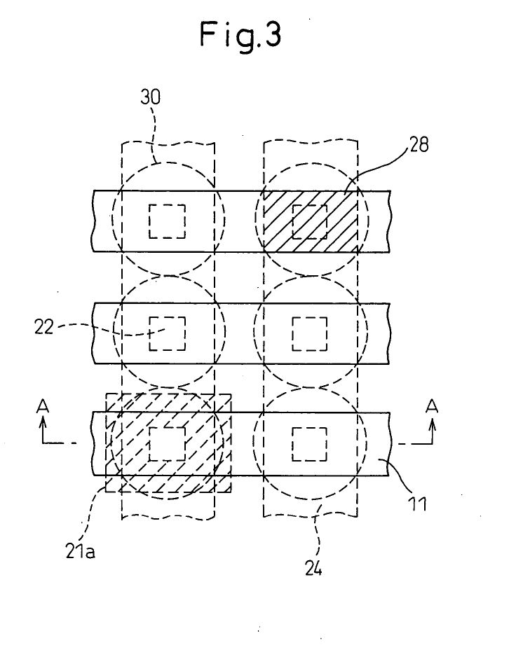

Alternatively, as shown in FIG. 3, island-like reflective films 21a may be formed one each facing each pixel 28 or covering each pixel 28. When forming the reflective film in such shapes, there is no need to provide the insulating film. In that case, the cost can be reduced because the number of processing steps can be reduced. Likewise, when the reflective film 21 is formed from an insulating reflective film, there is no need to provide the insulating film.

Here, a description will be given of the openings 22 formed in the reflective film 21. As earlier described, the reflective mode liquid crystal apparatus eliminates the need for a backlight because it displays an image by using ambient light from the outside environment. If a backlight is used, the apparatus can be used by reducing the brightness of the backlight. Therefore, the power consumption can be reduced, and thus an electronic apparatus using a liquid crystal apparatus of this type can be operated continuously for a longer time. However, the reflective mode liquid crystal apparatus has the problem that the display is difficult to view in a dark environment where the amount of available reflected light is low. On the other hand, the transmissive mode liquid crystal apparatus, which is not provided with a reflective film or reflective plate, consumes much power because it displays an image by using only the illumination from the backlight mounted underneath the liquid crystal device, and is therefore not suitable for portable electronic apparatuses. This has lead to the development of the transflective mode liquid crystal apparatus which has the characteristics of both the reflective mode and transmissive mode liquid crystal apparatuses.

There are two types of transflective mode liquid crystal apparatus: one is the type that uses, as the transflective film, a dielectric multilayer film or a transflective member constructed as a metal half mirror of Al, Ag, Al alloy, or the like, and the other is the type that uses, as shown in FIGS. 1 and 2, the transflective film formed by forming openings in selected portions of the reflective film made of a metal such as Al, Ag, or Al alloy and thereby allowing the light from the backlight to transmit therethrough. In the present patent application, the invention will be described by taking, as an example, the transflective mode liquid crystal apparatus that uses the transflective film formed by forming openings in selected portions of the reflective film.

In FIGS. 1 and 2, the reflective film 21 is formed with the openings 22 for transmitting light therethrough. The openings 22 are substantially centered on the respective image forming pixels 28. The openings 22 need not necessarily be centered on the respective pixels 28, but it is preferable that the openings be centered on the respective pixels 28 in order to facilitate efficient formation of the microlenses described later.

The openings 22 may each be formed in a square or rectangular shape when viewed from the top, as shown in FIG. 1, or may be formed in a circular or polygonal shape. Alternatively, openings of different shapes may be formed in the same liquid crystal apparatus.

It is preferable that the openings 22 be formed one for each pixel 28 when viewed from the top, as shown in FIG. 1, but a plurality of openings may be formed for each pixel.

The method of the present invention can be applied not only to passive liquid crystal apparatuses in which the pixels 28 are formed at positions where stripe electrodes intersect with each other, but also to active liquid crystal apparatuses in which the pixels are formed using active devices such as TFTs, MiMs, or DTFs.

In this case, if the pixels are formed with reflective electrodes (for example, electrodes formed from Ag or Al), an opening is formed in a portion of each reflective electrode.

It is preferable that the surface on which the second electrodes 24 are formed be planarized by forming an insulating film or a planarization film over the openings 22. In particular, in the case of an STN (Super Twisted Nematic) liquid crystal apparatus, the provision of such an insulating film or planarization film is essential because surface irregularities would greatly affect the image quality. Further, as will be described later, a color filter may be provided on each opening 22.

The plurality of microlenses 30 are formed integrally with or directly on the lower surface of the second substrate 20. If they are formed integrally, they are not formed integrally from the same material, because a glass material is used for both the second substrate 20 and the first substrate 10, while a resin material is used for the microlenses 30. Here, a resin material may be used for the second substrate 20.

The microlenses 30 may be formed in contact with the side of the second substrate 20 opposite from the side facing the liquid crystal layer. For example, the microlenses 30 are formed on the second substrate 20, but need not be in full intimate contact with the second substrate 20.

As shown in FIGS. 1 and 2, the microlenses 30 are arranged one for each pixel 28. Moreover, the center of each microlens 30 is aligned with the center of the corresponding opening 22 formed in the reflective film 21.

That is, the first substrate 10 and the second substrate 20 have the first electrodes 11 and the second electrodes 24 that define the positions of the pixels 28, the center of each pixel 28 being substantially aligned with the center of the corresponding one of the light-transmitting openings 22 of the reflective film 21 and the converging center of the corresponding one of the microlenses 30 (in the case of a lens whose cross section is a portion of a sphere, the center of the lens).

In this way, as the center of the opening 22 of the reflective film 21 for each pixel 28 is aligned with the center of the corresponding microlens, the light from the backlight 40 mounted behind the array of microlenses 30 is gathered by the microlenses 30 and passes through the respective openings 22; as a result, the amount of transmitted light increases, increasing the image brightness.

### Embodiment 1

Embodiments of a method for fabricating the microlenses 30 for the liquid crystal apparatus according to the present invention will be described below by taking as an example the transflective mode liquid crystal apparatus shown in FIGS. 1 and 2.

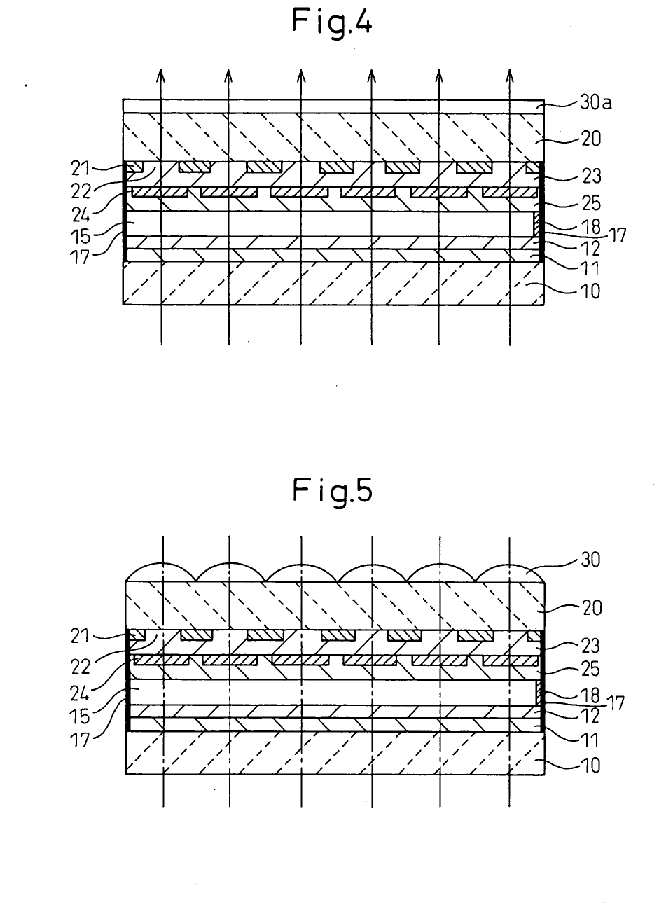

FIGS. 4 and 5 are process diagrams showing essential portions for explaining a method for manufacturing a liquid crystal apparatus equipped with microlenses according to a first embodiment of the present invention.

FIGS. 4 and 5 show an “empty cell” structure in which the first substrate 10, on which the first electrodes 11 and the first alignment film 12 are formed, and the second substrate 20, on which the second electrodes 24, the second alignment film 25, and the reflective film 21 as a reflective member having the light-transmitting openings 22 are formed, are bonded together by the sealing member 17 with the gap 15 provided between the substrates but not yet filled with the liquid crystal. In FIGS. 4 and 5, the structure shown in FIG. 2 is shown upside down.

The above empty cell is constructed by bonding together the first and second substrates 10 and 20 by the sealing member 17 having a liquid crystal injection port, but the liquid crystal is not yet injected into the cell.

Next, a description will be given of the method of forming the microlenses 30 on the above empty cell according to the first embodiment of the present invention.

First, as shown in FIG. 4, by using a prior known coating method such as a spinner method, a photocuring resin material is applied to form a photocuring resin layer 30a over the entire surface of the second substrate 20 opposite to the surface thereof facing the gap 15. Next, ultraviolet light or visible light (shown by arrows) that transmits through the second substrate 20 is radiated from below the first substrate 10. The light transmits through the first substrate 10, the first electrodes 11, the first alignment film 12, the gap 15, the second alignment film 25, the second electrodes 24, the insulating film 23 (or planarization film), the openings 22 in the reflective film 21, and the second substrate 20 in this order, and is introduced into the photocuring resin layer 30a which forms the microlenses 30. Since the radiated light is patterned in accordance with the openings 22 formed in the reflective film 21, the photocuring resin layer 30a is exposed in the pattern of microlenses with each lens centered with respect to each opening 22.

Next, the pattern is developed and the unexposed portions of the photocuring resin (the portions thereof not exposed to the radiation) are removed, to complete the formation of the microlenses 30 on the second substrate 20 as shown in FIG. 5. After that, the liquid crystal is injected into the gap 15 through the injection port formed in the sealing member 17, and the injection port is sealed with the sealant 18.

As described above, the formation of the microlenses 30 does not require the use of an exposure mask pattern usually required in prior art methods. Furthermore, as the centers of the pixels 28 defined by the first and second electrodes 11 and 24 are substantially coincident with the centers of the light-transmitting portions 22 when viewed in the direction normal to the first substrate 10, there is no need to accurately position the microlens mask pattern with respect to the openings 22 by manual work or by using a special jig or device. This serves to improve the production yield of the transflective mode liquid crystal apparatus having the microlenses, and thereby to reduce the production cost compared with the prior art.

In the prior art manufacturing methods, the first and second substrates are bonded together by the sealing member 17 after forming the microlenses 30 on the second substrate. Accordingly, the number of process steps performed after the formation of the microlenses increases, increasing the risk of scratching the microlenses. There is also the possibility that, during the fabrication process of the microlenses 30, dust and other foreign particles may adhere to the second substrate 20, resulting in a degradation of image quality due to the dust.

On the other hand, according to the manufacturing method shown in the first embodiment, as the microlenses are formed on the empty cell constructed by bonding together the first and second substrates by the sealing member 17 having a liquid crystal injection port, the number of process steps performed after that decreases. This serves to reduce the risk of scratching the microlenses and greatly improve the production yield.

Further, as the first and second substrates are bonded together before forming the microlenses, the structure is resistant to dust and other contaminants. This offers the effect that the structure is easy to handle and facilitates work. Further, during the fabrication process of the microlenses 30, dust and other foreign particles can be prevented from adhering to the second substrate 20 and degrading the image quality due to the adhering dust.

### Embodiment 2

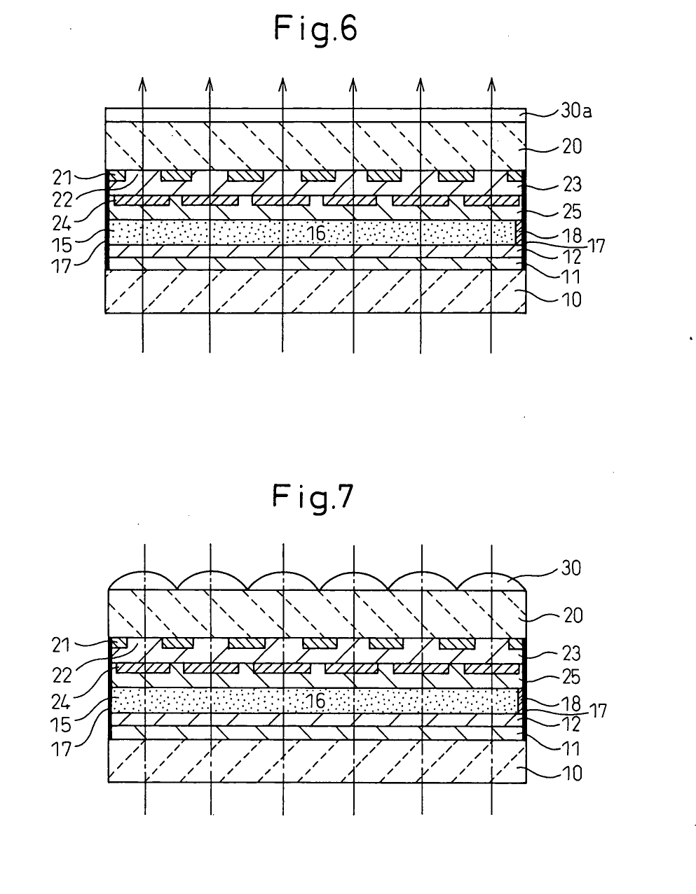

FIGS. 6 and 7 are process diagrams showing essential portions for explaining a method for manufacturing a liquid crystal apparatus equipped with microlenses according to a second embodiment of the present invention.

In the first embodiment, the microlenses 30 are formed on the cell before injecting the liquid crystal into it; in contrast, in the second embodiment shown in FIGS. 6 and 7, the microlenses 30 are formed on the cell after injecting the liquid crystal 16 into it.

FIGS. 6 and 7 show a cell structure in which the first substrate 10, on which the first electrodes 11 and the first alignment film 12 are formed, and the second substrate 20, on which the second electrodes 24, the second alignment film 25, and the reflective film 21 as a reflective member having the light-transmitting openings 22 are formed, are bonded together by the sealing member 17 with the gap 15 provided between the substrates and the gap 15 is filled with the liquid crystal 16. The liquid crystal 16 is injected through the injection port formed in the sealing member 17, and the injection port is sealed with the sealant 18 made of a resin material.

In FIGS. 6 and 7, the structure shown in FIG. 2 is shown upside down.

Next, a description will be given of the method of forming the microlenses 30 on the liquid crystal-filled and sealed cell according to the second embodiment of the present invention.

First, as shown in FIG. 6, by using a prior known coating method such as a spinner method, a photocuring resin material is applied to form a photocuring resin layer 30a over the entire surface of the second substrate 20 opposite to the surface thereof facing the liquid crystal layer 16. Next, ultraviolet light or visible light (shown by arrows) that can be transmitted through the second substrate 20 is radiated from below the first substrate 10. The light is transmitted through the first substrate 10, the first electrodes 11, the first alignment film 12, the liquid crystal layer 16, the second alignment film 25, the second electrodes 24, the insulating film 23 (or planarization film), the openings 22 in the reflective film 21, and the second substrate 20 in this order, and is introduced into the photocuring resin layer 30a which forms the microlenses 30. As the radiated light is patterned in accordance with the openings 22 formed in the reflective film 21, the photocuring resin layer 30a is exposed in the pattern of microlenses with each lens centered with respect to each opening 22.

Next, the pattern is developed and the unexposed portions of the photocuring resin (the portions thereof not exposed to the radiation) are removed, to complete the formation of the microlenses 30 on the second substrate 20 as shown in FIG. 7.

As the microlenses 30 are formed as described above, the second embodiment offers the same effect and advantage as described in connection with the first embodiment.

In addition to that, in the second embodiment, as the microlenses 30 are formed after completing the liquid crystal injecting step, the probability of scratching the microlenses further decreases and the production yield and quality improves, compared with the first embodiment.

Further, in the second embodiment, the light transmitted through the first substrate 10 is introduced into the photocuring resin layer 30a formed on the second substrate 20 after passing through the first electrodes 11, the second electrodes 24, and the openings 22 in the reflective film 21; accordingly, by driving the liquid crystal 16 by applying a voltage between the first and second electrodes 11 and 24, the amount of light to be transmitted therethrough can be controlled so as to provide an optimum amount of light for exposure. This eliminates the need to use a complex adjusting mechanism and allows the use of an inexpensive light projection device, achieving a further reduction in manufacturing cost.

### Embodiment 3

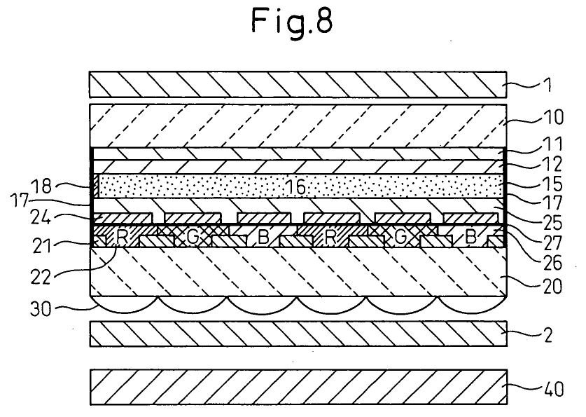

FIG. 8 is a diagram showing one example of a cross section of a color liquid crystal apparatus equipped with microlenses. The cross-sectional structure of the color liquid crystal apparatus shown in FIG. 8 is substantially the same as that shown in FIG. 2, but the difference from FIG. 2 is that color filters 26 and a protective film 27 are provided between the reflective film 21 with the openings 22 formed therein and the second electrodes 24.

In FIG. 8, reference numeral 10 is the first transparent substrate with the first electrodes 11 and the first alignment film 12 formed thereon. Reference numeral 20 is the second transparent substrate on one surface of which the microlenses 30 are formed, and on the other surface of which the reflective film 21 with the openings 22 formed therein, the color filters 26, the protective film 27, the second electrodes 24, and the second alignment film 25 are formed one on top of another. The first and second substrates 10 and 20 are arranged opposite each other with the gap 15 provided therebetween, and are bonded together by the sealing member 17. The liquid crystal 16 is injected into the gap 15 through the injection port formed in the sealing member 17, and the injection port is sealed with the sealant 18.

An image is formed by driving the liquid crystal 16 by applying a voltage between the first and second electrodes 11 and 24.

The color filters 26 are formed on the reflective film 21, that is, the color filters of three primary colors, red (R), green (G), and blue (B), are provided one for each pixel. For example, a pixel adjacent to a pixel provided with an R filter is provided with a G filter; likewise, a pixel adjacent to the pixel provided with the G filter is provided with a B filter, and a pixel adjacent to the pixel provided with the B filter is provided with an R filter.

The color filters 26 are covered with the planarization film or protective film 27 formed from a resin material for planarizing the upper surfaces of the filters. The insulating film 23 shown in FIG. 2 need not be provided, because the color filters 26 and the protective film 27 both having insulating capabilities are provided.

In the example shown in FIG. 8, the reflective film 21 is formed over the entire surface of the second substrate 20, but the reflective film may be formed in the shape of stripes extending along the respective second electrodes 24, each stripe having substantially the same width as that of each second electrode 24. Alternatively, an island-like reflective film may be formed facing each pixel or covering each pixel.

In FIG. 8, the first polarizer 1 is attached to the viewer side of the first substrate 10. The plurality of first stripe electrodes 11 made, for example, of indium tin oxide are formed parallel to each other on the same side of the first substrate 10 as the liquid crystal layer 16, and the first alignment film 12 is formed over the first electrodes 11.

On the other hand, the conductive reflective layer or reflective film 21 with the plurality of openings 22 formed therein is formed on the same side of the second transparent substrate 20 as the liquid crystal layer 16. The second polarizer 2 and the backlight 40 are mounted on the same side of the second substrate 20 as the microlenses 30.

Otherwise, the structure shown in FIG. 8 and the materials used for the reflective film, etc. are the same as those shown in FIG. 2, and therefore, the description thereof will not be repeated here.

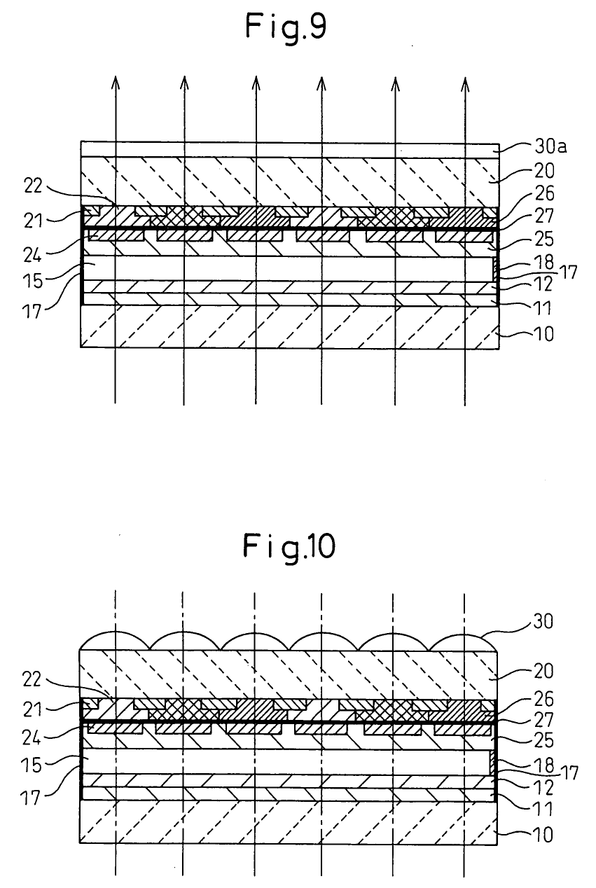

FIGS. 9 and 10 are process diagrams showing essential portions for explaining a method for manufacturing a color liquid crystal apparatus equipped with microlenses according to an embodiment (third embodiment) of the present invention.

FIGS. 9 and 10 show an “empty cell” structure in which the first substrate 10, on which the first electrodes 11 and the first alignment film 12 are formed, and the second substrate 20, on which the second electrodes 24, the second alignment film 25, the protective film 27, the color filters 26, and the reflective film 21 as a reflective member having the light-transmitting openings 22 are formed, are bonded together by the sealing member 17 with the gap 15 provided between the substrates but not yet filled with the liquid crystal. In FIGS. 9 and 10, the structure shown in FIG. 8 is shown upside down.

The above empty cell is constructed by bonding together the first and second substrates 10 and 20 by the sealing member 17 having a liquid crystal injection port, but the liquid crystal is not yet injected into the cell.

Next, a description will be given of the method of forming the microlenses 30 on the above empty cell according to the third embodiment of the present invention.

First, as shown in FIG. 9, by using a prior known coating method such as a spinner method, a photocuring resin material is applied to form a photocuring resin layer 30a over the entire surface of the second substrate 20 opposite to the surface thereof facing the gap 15. Next, ultraviolet light or visible light (shown by arrows) that can be transmitted through the second substrate 20 is radiated from below the first substrate 10. The light is transmitted through the first substrate 10, the first electrodes 11, the first alignment film 12, the gap 15, the second alignment film 25, the second electrodes 24, the insulating film 27, the color filters 26, the openings 22 in the reflective film 21, and the second substrate 20 in this order, and is introduced into the photocuring resin layer 30a which forms the microlenses 30. As the radiated light is patterned in accordance with the openings 22 formed in the reflective film 21, the photocuring resin layer 30a is exposed in the pattern of microlenses with each lens centered with respect to each opening 22.

Next, the pattern is developed and the unexposed portions of the photocuring resin (the portions thereof not exposed to the radiation) are removed, to complete the formation of the microlenses 30 on the second substrate 20 as shown in FIG. 10. After that, the liquid crystal is injected into the gap 15 through the injection port formed in the sealing member 17, and the injection port is sealed with the sealant 18.

As described above, the formation of the microlenses 30 does not require the use of an exposure mask pattern usually required in prior art methods. Furthermore, as the centers of the pixels 28 defined by the first and second electrodes 11 and 24 are substantially coincident with the centers of the light-transmitting portions 22 when viewed in the direction normal to the first substrate 10, there is no need to accurately position the microlens mask pattern with respect to the openings 22 by manual work or by using a special jig or device. This serves to improve the production yield of the transflective mode liquid crystal apparatus having the microlenses, and thereby to reduce the production cost compared with the prior art.

In the prior art manufacturing methods, the first and second substrates are bonded together by the sealing member after forming the microlenses 30 on the second substrate. Accordingly, the number of process steps performed after the formation of the microlenses increases, increasing the risk of scratching the microlenses. There is also the possibility that, during the fabrication process of the microlenses 30, dust and other foreign particles may adhere to the second substrate 20, resulting in a degradation of image quality due to the dust.

On the other hand, according to the manufacturing method shown in the third embodiment, as the microlenses are formed on the empty cell constructed by bonding together the first and second substrates by the sealing member 17 having a liquid crystal injection port, the number of process steps performed after that decreases. This serves to reduce the risk of scratching the microlenses and greatly improve the production yield.

Further, as the first and second substrates are bonded together before forming the microlenses, the structure is resistant to dust and other contaminants. This offers the effect that the structure is easy to handle and facilitates work. Further, during the fabrication process of the microlenses 30, dust and other foreign particles can be prevented from adhering to the second substrate 20 and degrading the image quality due to the adhering dust. As a result, the probability of inter-electrode shorts occurring between the first and second substrates decreases, and the reliability of the liquid crystal apparatus increases.

### Embodiment 4

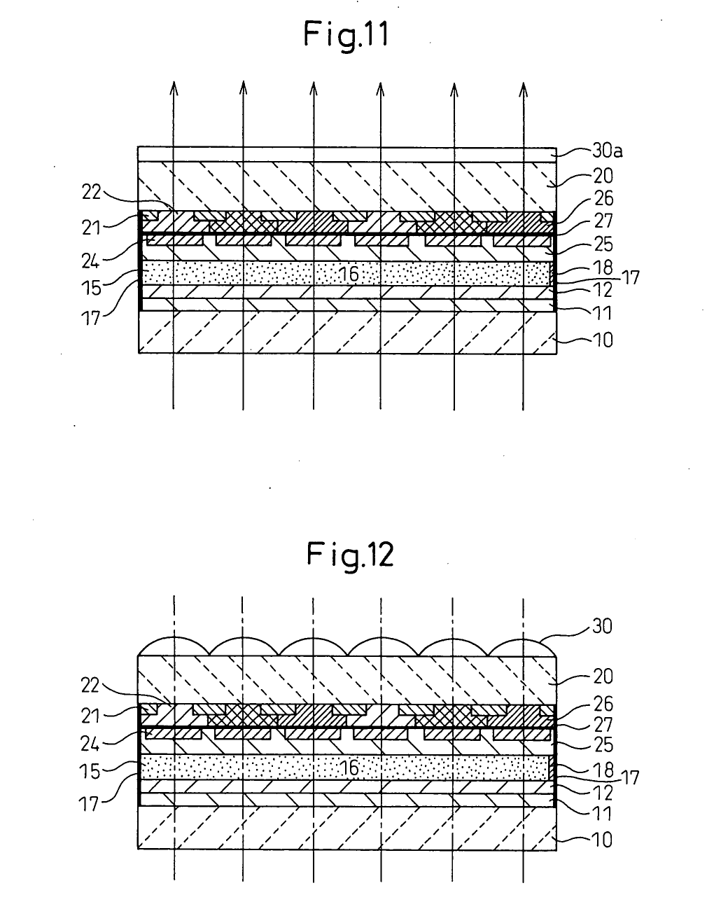

FIGS. 11 and 12 are process diagrams showing essential portions for explaining a method for manufacturing a liquid crystal apparatus equipped with microlenses according to a fourth embodiment of the present invention.

In the third embodiment, the microlenses are formed on the cell before injecting the liquid crystal into it; in contrast, in the fourth embodiment shown in FIGS. 11 and 12, the microlenses are formed on the cell after injecting the liquid crystal into it.

FIGS. 11 and 12 show a cell structure in which the first substrate 10, on which the first electrodes 11 and the first alignment film 12 are formed, and the second substrate 20, on which the second electrodes 24, the second alignment film 25, the protective film 27, the color filters 26, and the reflective film 21 as a reflective member having the light-transmitting openings 22 are formed, are bonded together by the sealing member 17 with the gap 15 provided between the substrates and the gap 15 is filled with the liquid crystal 16. The liquid crystal 16 is injected through the injection port formed in the sealing member 17, and the injection port is sealed with the sealant 18 made of a resin material.

In FIGS. 11 and 12, the structure shown in FIG. 8 is shown upside down.

Next, a description will be given of the method of forming the microlenses 30 on the liquid crystal-filled and sealed cell according to the present invention.

First, as shown in FIG. 11, by using-a prior known coating method such as a spinner method, a photocuring resin material is applied to form a photocuring resin layer 30a over the entire surface of the second substrate 20 opposite to the surface thereof facing the liquid crystal layer 16. Next, ultraviolet light or visible light (shown by arrows) that can be transmitted through the second substrate 20 is radiated from below the first substrate 10. The light is transmitted through the first substrate 10, the first electrodes 11, the first alignment film 12, the liquid crystal layer 16, the second alignment film 25, the second electrodes 24, the protective film 27, the color filters 26, the openings 22 in the reflective film 21, and the second substrate 20 in this order, and is introduced into the photocuring resin layer 30a which forms the microlenses 30. Since the radiated light is patterned in accordance with the openings 22 formed in the reflective film 21, the photocuring resin layer 30a is exposed in the pattern of microlenses with each lens centered with respect to each opening 22.

Next, the pattern is developed and the unexposed portions of the photocuring resin (the portions thereof not exposed to the radiation) are removed, to complete the formation of the microlenses 30 on the second substrate 20 as shown in FIG. 12.

Since the microlenses 30 are formed as described above, the fourth embodiment offers the same effect and advantage as described in connection with the third embodiment.

In addition to that, in the fourth embodiment, as the microlenses 30 are formed after completing the liquid crystal injecting step, the probability of scratching the microlenses further decreases and the production yield and quality improves, compared with the third embodiment.

Further, in the fourth embodiment, the light transmitted through the first substrate 10 is introduced into the photocuring resin layer 30a formed on the second substrate 20 after passing through the first electrodes 11, the second electrodes 24, and the openings 22 in the reflective film 21; accordingly, by driving the liquid crystal 16 by applying a voltage between the first and second electrodes 11 and 24, the amount of light to be transmitted therethrough can be controlled so as to provide an optimum amount of light for exposure. This eliminates the need to use a complex adjusting mechanism and allows the use of an inexpensive light projection device, achieving a further reduction in manufacturing cost.

### Embodiment 5

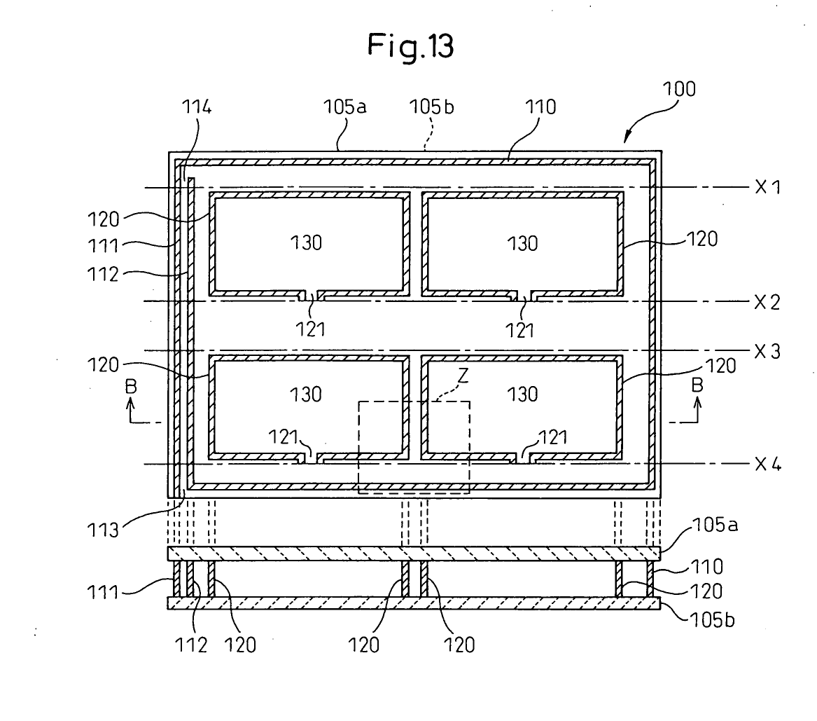

FIGS. 13, 14, and 15 are process diagrams showing essential portions for explaining a method for manufacturing a liquid crystal apparatus equipped with microlenses according to a fifth embodiment of the present invention.

FIG. 13 shows a structure 100 in which a plurality of empty cells 130 are formed between large-size substrates. In FIG. 13, the upper part shows a perspective plan view of the large-size substrates (hereinafter referred to as the “mother substrates”) with the plurality of empty cells 130 formed therebetween, and the lower part shows a cross-sectional view taken along line B-B in the perspective plan view shown in the upper part.

In FIG. 13, the first mother substrate 105a and the second mother substrate 105b are bonded together by first and second sealing members 110 and 120. The first sealing member 110 is formed along the edges of the mother substrates, with the end portions 111 and 112 of the sealing member extending substantially parallel to each other to form a double sealing structure. Openings 113 and 114 are provided at the outside and inside ends, respectively, of the double sealing portion, thus forming a communicating passage.

Each individual cell 130 is formed in the portion enclosed by the second sealing member 120. In the portion where each cell 130 is formed between the first mother substrate 105a and the second mother substrate 105b, the first and second electrodes and other component elements are provided as shown in FIGS. 2 and 8, but these component elements are not shown here.

In FIG. 13, the second sealing member 120 is provided with a liquid crystal injection port 121 through which the liquid crystal is injected.

In FIG. 13, the end portions of the first seal 110 are formed in a double sealing structure, and the communicating passage is formed by providing the openings 113 and 114 at the outside and inside ends, respectively, of the double sealing portion; the reason for this will be described below.

The first mother substrate 105a and the second mother substrate 105b are held opposite each other with a gap provided therebetween by interposing spacer members between them; in this condition, the first mother substrate 105a and the second mother substrate 105b are bonded together under heat by using the first and second sealing members 110 and 120. At this time, if the gap were hermetically sealed with the first sealing member 110, the mother substrates would break due to the thermal expansion of the air entrapped in the inside center portion sandwiched between the first mother substrate 105a and the second mother substrate 105b. To prevent the expanding air from breaking the mother substrates, in the fifth embodiment, the communicating passage having the openings 113 and 114 is provided to vent the entrapped air to the outside.

Here, if the sealing members are formed from an ultraviolet curing resin, there is no need to apply heat for bonding, and therefore, the first sealing member 110 need not be provided with the communicating passage. However, the reliability increases when the substrates are bonded together under heat by using sealing members made of epoxy or like resin.

Further, the double sealing portion (111, 112) of the first sealing member 110 has the function of preventing unwanted solutions from entering inside the first sealing member and penetrating into the empty liquid crystal layer of each liquid crystal cell 130 during the cleaning and wet developing steps performed as post-processing after the bonding and sealing steps.

Here, the double sealing portion of the first sealing member 110 is not limited to the particular shape shown in FIG. 13, but may be formed in any suitable shape as long as it is formed so as to prevent the penetration of the developer and cleaning solutions. For example, in the structure shown in FIG. 13, the first sealing member 110 is formed with 1 turn+about ¼ of a turn, but it may be formed with 1 turn+about 2/4 of a turn, one turn+¾ of a turn, or 2 turns.

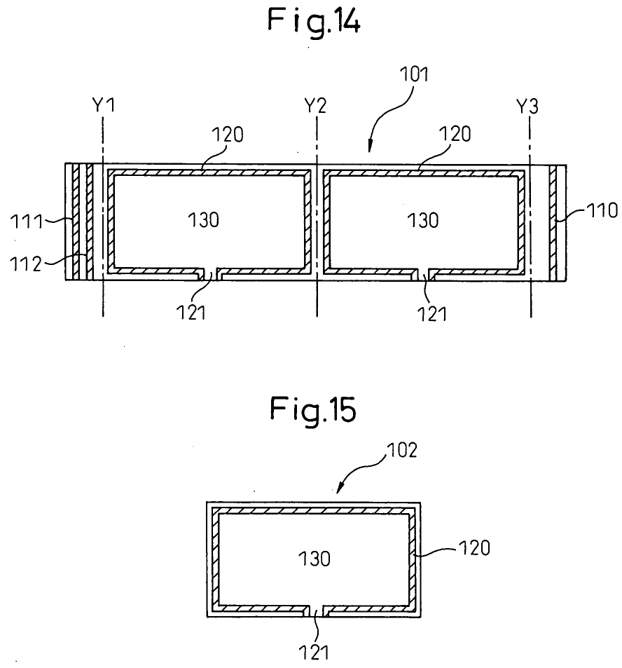

FIG. 14 shows a rectangular-shaped substrate 101 obtained by cutting the mother substrate 100, with the plurality of empty cells formed thereon, along horizontal cutting lines X (X1, X2, X3, X4).

The plurality of empty cells 130 are arranged along the horizontal direction on the rectangular-shaped substrate 101. The injection ports 121 of all the cells open in the same direction, and the liquid crystal is injected through these injection ports into all the cells 130 at once by using a vacuum injection method. After injecting the liquid crystal into the empty cells, each injection port 121 is sealed with a resin material. For example, an ultraviolet curing resin or a thermosetting resin is used as the resin material.

In this way, the cells, rectangular in shape and arrayed in the horizontal direction, are each formed by injecting the liquid crystal into the space enclosed by the second seal member 120.

Then, the rectangular cell array is cut along vertical cutting lines Y (Y, Y2, Y3), to obtain each individual cell 102 shown in FIG. 15.

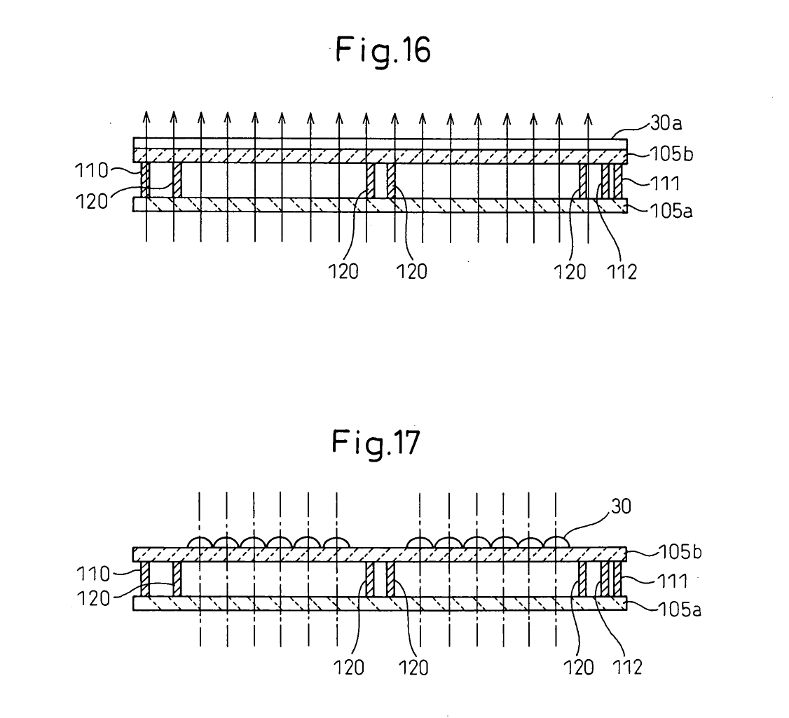

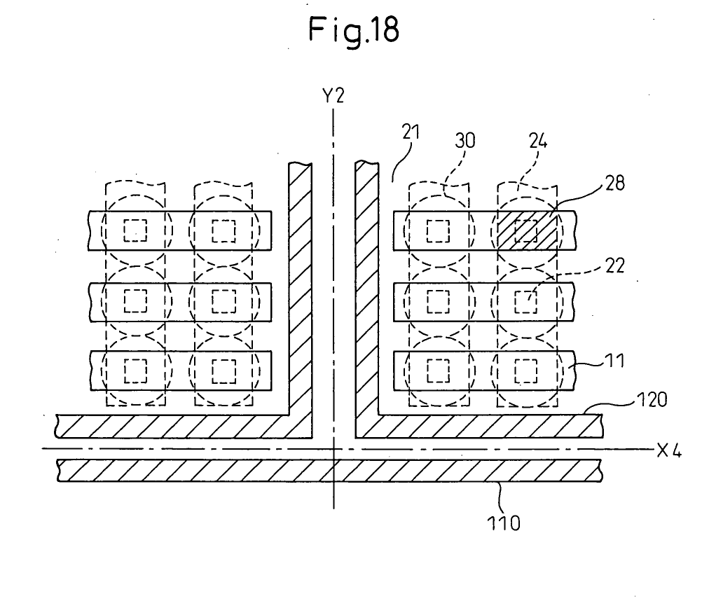

Next, the process for forming the microlenses 30 on the mother substrate having the plurality of empty cells thus formed will be described with reference to FIGS. 16 and 17. FIG. 16 is the same diagram as that shown in FIG. 13, that is, the cross-sectional view of the mother substrates taken along line B-B. However, the cross-sectional view shown in FIG. 13 is shown upside down in FIG. 16.

In FIG. 16, the first mother substrate 105a and the second mother substrate 105b are bonded together by the first and second sealing members 110 and 120. The first sealing member 110 is formed along the edges of the mother substrates, with the end portions 111 and 112 of the sealing member extending substantially parallel to each other to form a double sealing structure. As shown in FIG. 13, the openings 113 and 114 are provided at the outside and inside ends, respectively, of the double sealing portion, thus forming a communicating passage.

Each individual cell 130 is formed in the portion enclosed by the second sealing member 120. In the portion where each cell 130 is formed between the first mother substrate 105a and the second mother substrate 105b, the first and second electrodes and other component elements are provided as shown in FIG. 2, but these component elements are not shown here. Further, color filters may be provided as shown in FIG. 8.

In FIG. 16, by using a prior known coating method such as a spinner method, a photocuring resin material is applied to form a photocuring resin layer 30a over the entire surface of the second mother substrate 105b opposite to the surface thereof facing the liquid crystal layer. Instead of the spinner method, other suitable methods such as a squeeze method or printing method can be used as the coating method.

Next, ultraviolet light or visible light (shown by arrows) that can be transmitted through the second mother substrate 105b is radiated from below the first mother substrate 105a. The light is transmitted through the first mother substrate 105a, the first electrodes 11, the first alignment film 12, the gap 15, the second alignment film 25, the second electrodes 24, the insulating film 23, the openings 22 in the reflective film 21, and the second mother substrate 105b in this order, and is introduced into the photocuring resin layer 30a which forms the microlenses 30.

As the radiated light is patterned in accordance with the openings 22 formed in the reflective film 21, the photocuring resin layer 30a is exposed in the pattern of microlenses with each lens centered with respect to each opening 22.

Next, the pattern is developed and the unexposed portions of the photocuring resin (the portions thereof not exposed to the radiation) are removed, to complete the formation of the microlenses as shown in FIG. 17.

The microlenses 30 are thus formed on the second mother substrate 105b.

FIG. 18 is an enlarged plan view in perspective showing the portion indicated by Z in FIG. 13 after the microlenses 30 have been formed. In FIG. 18, reference numeral 11 indicates a first electrode, and 24 a second electrode, and the liquid crystal layer is sandwiched between the first and second electrodes, forming a pixel 28 where the first and second electrodes 11 and 24 overlap. In FIG. 18, the reflective film 21 is formed over the entire surface underneath the array of second electrodes 24, and the openings 22 as light-transmitting portions are formed in the reflective film 21, one each in a position corresponding to each pixel 28. The openings 22 shown here are rectangular in shape, but may be formed in any other suitable shape, such as a stripe shape, a polygonal shape, or a circular shape.

Reference numeral 30 indicates an array of microlenses formed below the reflective film 21 at positions opposite the respective openings 22.

Reference numeral 110 indicates the first sealing member, and 120 the second sealing member. Each individual cell 130 is formed in the portion enclosed by the second sealing member 120.

Here, in FIGS. 13 and 18, when not forming the reflective layer over the entire surface, a light-blocking member should be provided in any portion, including the portions of the cutting lines X and Y, where the cells 130 are not formed; by so doing, the microlenses 30 will not be formed on these portions. In this case, the mother substrate and the rectangular-shaped mother substrate, on which the microlenses have been formed, can be cut by using a conventional cutting method, because the microlenses are not formed on the portions along which the substrate structure is cut; this eliminates the need for setting new conditions for cutting, and serves to reduce the cost.

After the microlenses 30 are formed on the mother substrate as shown in FIG. 17, the mother substrate structure is cut into individual cells as shown in FIG. 15. Then, as shown in FIG. 2, the second polarizer 2 and the backlight 40 are mounted on the same side as the microlenses 30, and the first polarizer 1 is attached to the first substrate 10.

For the backlight, technology has advanced in recent years, and fluorescent tubes, flat fluorescent lamps, light-emitting diodes (LEDs), and electroluminescent (EL) lamps are available for use as the light source. When using fluorescent tubes or LEDs, a backlighting configuration known as side lighting is employed, in which case a light conducting plate is usually used in combination with the light source.

The polarizer may be attached directly to the microlenses, or may be spaced away from the microlenses by providing a gap or a gap filler therebetween.

Alternatively, the curved lens surfaces on the side of the microlens array opposite from the substrate may be planarized by using a lens planarizing material that does not impair the lens function of the microlenses, and the polarizer may be mounted on the planarized surface.

### Embodiment 6

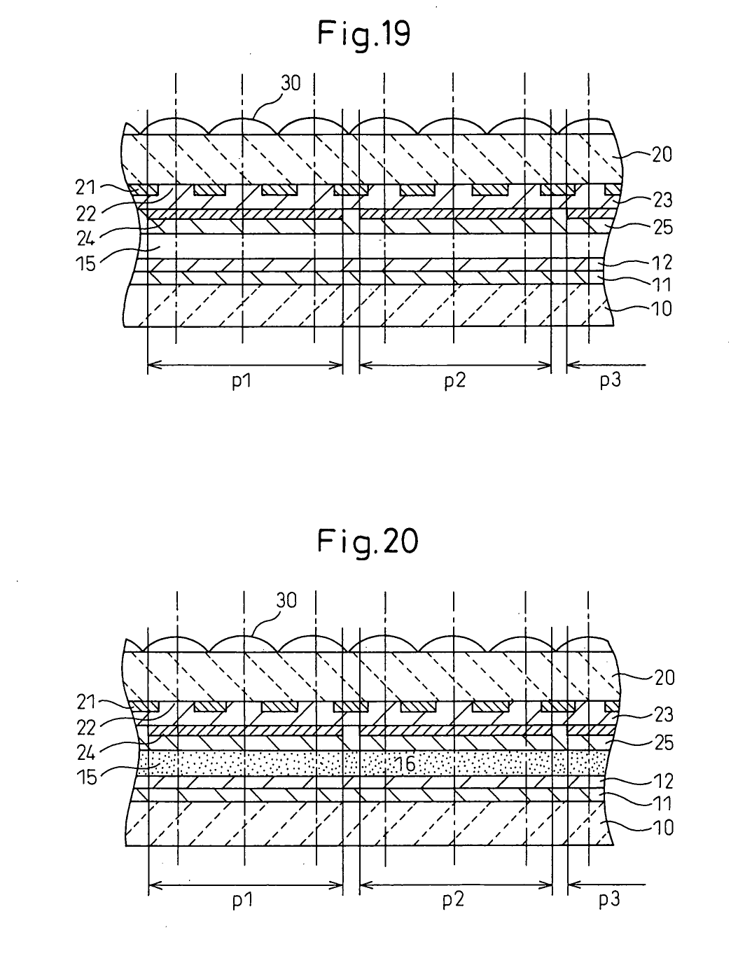

FIG. 19 is a process diagram showing essential portions for explaining a method for manufacturing a liquid crystal apparatus equipped with microlenses according to a sixth embodiment of the present invention. The sixth embodiment is a modification of the first embodiment.

FIG. 19 shows an “empty cell” structure in which the first substrate 10, on which the first electrodes 11 and the first alignment film 12 are formed, and the second substrate 20, on which the second electrodes 24, the second alignment film 25, and the reflective film 21 as a reflective member having the light-transmitting openings 22 are formed, are bonded together by the sealing member 17 (see FIG. 2) with the gap 15 provided between the substrates but not yet filled with the liquid crystal. In FIG. 9, the structure shown in FIG. 2 is shown upside down.

The above empty cell is constructed by bonding together the first and second substrates 10 and 20 by the sealing member 17 having a liquid crystal injection port, but the liquid crystal is not yet injected into the cell.

In the case of the empty cell shown in FIG. 19, a plurality of light-transmitting portions 22 is provided for each of the pixels 28 (see FIG. 1) defined at the intersections between the first electrodes 11 on the first substrate 10 and the second electrodes 24 on the second substrate 20. In FIG. 19, p1, p2, p3, . . . each indicate one pixel, and a plurality of openings 22 are provided for each pixel 28.

Accordingly, when ultraviolet light or visible light that can be transmitted through the second substrate 20 is radiated from below the first substrate 10, as shown in FIG. 4, the light passes through the first substrate 10, the first electrodes 11, the first alignment film 12, the gap 15, the second alignment film 25, the second electrodes 24, the insulating film 23 (or planarization film), the openings 22 in the reflective film 21, and the second substrate 20 in this order, and the microlenses 30 are formed at positions corresponding to the respective openings 22.

Since a plurality of openings 22 are provided for each of the pixels p1, p2, p3, . . . , as shown in FIG. 19, a plurality of microlenses 30 are formed for each pixel. The remainder of the process steps is the same as that described in the first embodiment.

### Embodiment 7

FIG. 20 is a process diagram showing essential portions for explaining a method for manufacturing a liquid crystal apparatus equipped with microlenses according to a seventh embodiment of the present invention. The seventh embodiment is a modification of the second embodiment.

In the sixth embodiment, the microlenses are formed on the cell before injecting the liquid crystal into it; in contrast, in the seventh embodiment shown in FIG. 20, the microlenses 30 are formed on the cell after injecting the liquid crystal 16 into it.

FIG. 20 shows a cell structure in which the first substrate 10, on which the first electrodes 11 and the first alignment film 12 are formed, and the second substrate 20, on which the second electrodes 24, the second alignment film 25, and the reflective film 21 as a reflective member having the light-transmitting openings 22 are formed, are bonded together by the sealing member 17 with the gap 15 provided between the substrates and the gap 15 is filled with the liquid crystal 16. The liquid crystal 16 is injected through the injection port formed in the sealing member 17, and the injection port is sealed with the sealant 18 made of a resin material.

In FIG. 20, the structure shown in FIG. 2 is shown upside down.

In the case of the cell filled with the liquid crystal 16 as shown in FIG. 20, a plurality of light-transmitting portions 22 is provided for each of the pixels 28 (see FIG. 1) defined at the intersections between the first electrodes 11 on the first substrate 10 and the second electrodes 24 on the second substrate 20. In FIG. 20, p1, p2, p3, . . . each indicate one pixel, and a plurality of openings 22 are provided for each pixel 28.

Accordingly, when ultraviolet light or visible light that can be transmitted through the second substrate 20 is radiated from below the first substrate 10, the light passes through the first substrate 10, the first electrodes 11, the first alignment film 12, the liquid crystal layer 16, the second alignment film 25, the second electrodes 24, the insulating film 23 (or planarization film), the openings 22 in the reflective film 21, and the second substrate 20 in this order, and the microlenses 30 are formed, as shown in FIG. 20, at positions corresponding to the respective openings 22.

As a plurality of openings 22 are provided for each of the pixels p1, p2, p3, . . . , as shown in FIG. 20, a plurality of microlenses 30 are formed for each pixel. The remainder of the process steps is the same as that described in the second embodiment.

1. A method for manufacturing an apparatus using an electro-optical modulating material, comprising the steps of:
(a) forming a cell by bonding together a first substrate and a second substrate by a sealing member with a gap yet to be filled with said electro-optical modulating material provided between said first and said second substrate, wherein said first substrate includes at least a first electrode and said second substrate includes at least a second electrode and an optically reflective member having a light-transmitting portion;
(b) forming a photocuring resin layer on a surface of said second substrate of said cell opposite from said gap; and
(c) irradiating said photocuring resin layer with light projected from said first substrate and passed through said gap, said light-transmitting portion, and said second substrate, and thereby forming a microlens for converging light, which is directed into said gap passing through said second substrate, onto said light-transmitting portion.

2. A method for manufacturing an apparatus using an electro-optical modulating material, comprising the steps of:
(a) forming a cell by bonding together a first substrate and a second substrate by a sealing member with a gap yet to be filled with said electro-optical modulating material provided between said first and said second substrate, wherein said first substrate includes at least a first electrode and said second substrate includes at least a second electrode and an optically reflective member having a light-transmitting portion;
(b) forming a photocuring resin layer on a surface of said second substrate of said cell opposite from said gap;
(c) filling said electro-optical modulating material into said gap and sealing said gap; and
(d) irradiating said photocuring resin layer with light projected from below said first substrate and passed through said gap filled with said electro-optical modulating material, said light-transmitting portion, and said second substrate, and thereby forming a microlens for converging light, which is directed into said gap filled with said electro-optical modulating material passing through said second substrate, onto said light-transmitting portion.

3. A method as claimed in claim 1 or 2, wherein color filters are provided between said first substrate and said second substrate.

4. A method as claimed in claim 1 or 2, wherein the center of a pixel defined by said first electrode on said first substrate and said second electrode on said second substrate is substantially coincident with the center of said light-transmitting portion when viewed in a direction normal to said first substrate.

5. A method as claimed in claim 1 or 2, wherein a plurality of said light-transmitting portions are provided for each pixel defined by said first electrode on said first substrate and said second electrode on said second substrate, and a plurality of said microlenses are formed for said each pixel.

6. A method as claimed in claim 1 or 2, wherein said microlens forming step is followed by the steps of:
(e) providing a first polarizer on a side of said first substrate opposite from said gap; and
(f) providing a second polarizer and a backlight on the same side as said microlens.

7. A method as claimed in claim 2, wherein said electro-optical modulating material to be filled into said gap is a liquid crystal material.

8. A method as claimed in claim 7 wherein, in the step (d) of forming said microlens by irradiating said photocuring resin layer with light, the amount of said light transmitted for irradiation is controlled by driving said filled liquid crystal by applying a voltage between said first electrode and said second electrode.

9. A method for manufacturing an apparatus using an electro-optical modulating material, comprising the steps of:
(a) forming a plurality of cells by bonding together a first mother substrate and a second mother substrate by a sealing member with a gap yet to be filled with said electro-optical modulating material provided between said first and said second mother substrates, said sealing member comprising a first sealing member provided along edges of said first and second mother substrates and a second sealing member provided so as to enclose each of said cells, wherein said first mother substrate includes a plurality of cell forming portions, each of which includes at least a first electrode, and said second mother substrate includes a plurality of cell forming portions, each of which includes at least a second electrode and an optically reflective member having a light-transmitting portion;
(b) forming a photocuring resin layer on a surface of said second mother substrate opposite from said gap; and
(c) irradiating said photocuring resin layer with light projected from said first mother substrate and passed through said gap, said light-transmitting portion, and said second mother substrate, and thereby forming a microlens for converging light, which is directed into said gap passing through said second mother substrate, onto said light-transmitting portion.

10. A method as claimed in claim 9, wherein a light-blocking member is provided in any portion of said first and second mother substrates other than said cell forming portions so that said microlens will not be formed on said portion.

11. A method as claimed in claim 9, wherein the center of a pixel defined by said first electrode on said first mother substrate and said second electrode on said second mother substrate is substantially coincident with the center of said light-transmitting portion when viewed in a direction normal to said first mother substrate.

12. A method as claimed in claim 9, wherein said first sealing member forms a double seal along a portion of said edges of said mother substrates, and said double seal forms a passage communicating between an outside environment and said gap formed between said first and second mother substrates.

13. A method as claimed in claim 9, wherein said microlens forming step is followed by the step of:
(d) cutting said first and second mother substrates, which contain said plurality of cells with said microlens formed thereon, into rectangular pieces, and injecting said electro-optical modulating material through an injection port formed in said second sealing member and thereafter sealing each of said cells.

14. A method as claimed in claim 13, wherein the step of injecting said electro-optical modulating material and sealing each of said cells is followed by the step of:
(e) cutting said plurality of cells, each filled with said electro-optical modulating material and sealed, into separate individual cells.
